(19) United States
(12) Patent Application Publication
(10) Pub. No.: US 2005/0217747 A1
(43) Pub. Date: Oct. 6, 2005

(54) Thermoplastic pipe and liners

(76) Inventors: Paul James Buriak, Cypress, TX (US); Wen Li, Houston, TX (US)

Correspondence Address: ExxonMobil Chemical Company;Law Technology, P.O. Box 2149, Baytown, TX, 77522-2149, US

(21) Appl. No.: 10/813,380

(22) Filed: Mar. 30, 2004

(51) Int. Cl. B65D 1/00; F16L 1/00; B32B 1/08; B29D 23/00

(52) U.S. Cl. 138/140; 138/141; 138/142

(57) ABSTRACT

Thermoplastic pipe and liners utilizing a barrier layer between two thermoplastic layers useful in preventing diffusion of certain gases across the barrier layer. The thermoplastic pipe and liners are useful in the transportation of corrosive gases and fluids and in providing internal protection to steel and other metallic tubulars, particularly in oil field and other applications requiring the transportation of corrosive gases and fluids.

### FIELD OF THE INVENTION

This invention relates to thermoplastic pipe and liners with improved gas barrier properties. In particular, this invention relates to thermoplastic pipe and thermoplastic liners and their use in oil and gas and other operations for the transport of corrosive or erosive gaseous and liquid materials.

### BACKGROUND OF THE INVENTION

Carbon steel and other tubulars have long been used to transport and deliver gaseous and liquid materials. Such tubulars have specifically been used in oil field applications for drill pipe, production casing, production tubing, flowlines, pipelines, and carbon dioxide injection wells. Tubulars have also been used in non-oil field applications such as sewer service and transport of various chemicals. In many of these applications, it is desirable to protect the internal surface of such tubulars from corrosive and erosive forces that may cause leaks and other failures of the tubulars. Corrosive agents such as carbon dioxide, hydrogen sulfide, and various salts present in produced crude oils and natural gas can attack unprotected carbon steel and other metallic tubulars.

In oil field applications, many approaches to minimize the effect of corrosive and erosive forces on the internal surface of tubulars have been used. For example, chemical treatments, which use various corrosion inhibitors, typically in liquid form, have been injected into tubulars to minimize corrosion. Chemical treatments are not usually preferred since such treatments require continuous injection, may be expensive, and provide no protection against erosive forces. Tubulars (pipes) used for carrying produced water, including brackish water, have also been internally lined with cement to protect the internal pipe surface.

The most common method of providing internal surface protection of oil field tubulars is the application of thin coatings to new or reconditioned tubulars. These thin coatings create a physical barrier between the internal tubular surface and the corrosive and erosive environment created by the materials being conveyed by the tubular. Examples of commonly used coatings to protect the internal surface of steel tubulars are polymer type coatings, including polyamines, polyamides, epoxy phenolics, and epoxy novolacs. While providing some protection, polymer and epoxy coatings may not be useful or provide satisfactory performance in certain applications. For example, many polymer and epoxy coatings are expensive and difficult to apply. Frequently, the polymer or epoxy coating does not adequately adhere to the internal tubular surface. Such coatings may lose adhesion with the tubular surface under harsh operating conditions, such as during the production of corrosive materials or during the running of oil field tools or other equipment through the tubular. The adhesion loss may be such that the coating will separate entirely from the tubular surface and expose the tubular surface to the corrosive properties of the fluids and gases moving through the tubular.

Also used, though not as common as the use of polymer and epoxy coatings, are liners that are inserted to protect the tubulars. Examples of such liners and methods to install such liners are described in U.S. Pat. No. 5,320,388. The '388 patent describes the placement of an ultrahigh molecular weight, high-density polyethylene flanged liner into threaded well tubulars. U.S. Pat. No. 5,320,388 is hereby incorporated by reference in its entirety. Other examples of tubular liners and methods to install such liners are described in U.S. Pat. No. 6,596,121 B1. The '121 patent describes the use of a resin impregnated fiber preformed material installed and inflated along a length of an oil field tubular. U.S. Pat. No. 6,596,121 B1 is hereby incorporated by reference in its entirety. Oil field service providers, such as Western Falcon, of Houston, Tex., have provided thermoplastic liners of polyolefin and seamless high-density polyethylene materials since before 1994.

While thermoplastic liners provide many benefits and some protection to the internal surface of a steel tubular, it has been determined that in certain applications, specifically those handling gases and liquids containing corrosive materials, such as carbon dioxide or hydrogen sulfide gases, many thermoplastics fail to provide an acceptable barrier to such corrosive materials. Corrosive materials permeating the thermoplastic liner will aggressively attack and may ultimately cause failure of the tubular, especially tubulars of carbon steel. For example, at elevated pressures and temperatures and in the presence of water, carbon dioxide will form dilute carbonic acid that will attack and destroy carbon steel and other metallic tubulars. Similarly, at elevated pressures and temperatures and in the presence of water, hydrogen sulfide gas will form dilute sulfuric acid that will likewise attack and destroy carbon steel and other metallic tubulars.

While some thermoplastic liners may adequately prevent permeation of most liquids and certain gases, such as oxygen, they are usually less effective at preventing carbon dioxide permeation. In most thermoplastics, carbon dioxide permeation rates are nearly three times higher than oxygen permeation rates. For example, a high density polyethylene having an oxygen permeability rate of 75 cm³/mm/m²/day/atm might display a carbon dioxide permeability rate of 200 cm³/mm²/day/atm, or a polypropylene having a oxygen permeability rate of 90 cm³/mm/m²/day/atm might display a carbon dioxide permeability rate of 250 cm³/mm/m²/day/atm, Polypropylene, The Definitive User's Guide and Databook, Clive Maier and Teresa Calafut, at page 130, (1998). Accordingly, a thermoplastic that provides a sufficient barrier to oxygen may not provide a sufficient barrier to carbon dioxide or other corrosive gases.

As will be discussed below, numerous polymeric materials are capable of providing good permeability protection as a barrier material from certain corrosive gases, such as carbon dioxide. However, it is not practical to make an entire pipe or liner from such a barrier material alone. Specifically, a pipe or liner made from a single barrier material alone could be inadequate or otherwise fail to meet specific service requirements for one or more of the following reasons: (i) the permeability properties of such a pipe or liner would be reduced or destroyed due to direct exposure to the fluids or other materials to be transported, (ii) such a pipe or liner would have inadequate structural integrity or rigidity, and (iii) such a pipe or liner would be too expensive to produce for most commercial applications. An economical pipe or liner meeting the service requirements and providing adequate permeability protection is a primary purpose of the present invention.

To improve the performance of thermoplastic pipes and liners, the present inventors have developed multilayered pipes and liners featuring a low permeability barrier layer to protect the internal surface of steel and other rigid tubulars combined with thermoplastic layers to provide structural integrity for and protection to the barrier layer. Specifically, the invention relates to thermoplastic pipes having three layers, including a barrier layer, most preferably an ethylene vinyl alcohol (EVOH) copolymer, between two thermoplastic layers, and a method whereby the three-layer liner is preferably produced through a co-extrusion process. Additionally, the invention relates to thermoplastic pipes having five layers, including a barrier layer, most preferably an ethylene vinyl alcohol copolymer, between two adhesive layers with each adhesive layer covered by a thermoplastic layer and a method whereby the five-layer liner is produced through a co-extrusion process. Further, the invention relates to multilayered thermoplastic pipe, including a barrier layer, most preferably an ethylene vinyl alcohol copolymer, with a reinforcing structure to allow operation in high pressure and temperature environments.

### SUMMARY OF THE INVENTION

This invention provides multilayered thermoplastic pipes and liners capable of providing a low permeability barrier to certain gaseous materials. Additionally, methods of manufacture of such pipes and liners are also disclosed.

The pipes and liners of the present invention generally comprise a barrier layer between two thermoplastic layers. The liners are preferably in tubular form for use in oil field and other applications to transport gases and liquids with corrosive properties. The liners provide a cost effective method to reduce the exposure of the internal surface of tubulars carrying corrosive gases and fluids and extend the life of the tubular.

In particular, the multilayer pipe or liner of the present invention would include:
(a) a first thermoplastic tubular structure comprising (i) a polyolefin material selected from the group consisting of polypropylene, copolymers of polypropylene with other olefins, polyethylene, and copolymers of ethylene with other olefins and (ii) a functionalized polymer, an acid terpolymer, or an ethylene acrylic acid copolymer;
(b) a second thermoplastic tubular structure comprising (i) a polyolefin material selected from the group consisting of polypropylene, copolymers of polypropylene with other olefins, polyethylene, and copolymers of ethylene with other olefins and (ii) a functionalized polymer, an acid terpolymer, or an ethylene acrylic acid copolymer;
(d) the second thermoplastic tubular covering the first thermoplastic tubular structure; and
(e) a barrier layer disposed between the first thermoplastic tubular structure and the second thermoplastic tubular structure.

In any of the embodiments described, the functionalized polymer could include maleic anhydride.

In any of the embodiments described, the barrier layer could have a carbon dioxide permeability of less than 0.50 cm³/100 cm²/day/100 kPa, more preferably less than 0.10 cm³/100 cm²/day/100 kPa, and most preferably less than 0.01 cm³/100 cm²/day/100 kPa.

In any of the embodiments described, the first thermoplastic tubular structure and the second thermoplastic tubular structure could each further comprise a hydrocarbon resin, the hydrocarbon resin having a melt flow rate of between about 10 and 40 g/10 min. at 230° C., 2160 g and a density of between about 0.90 and 1.10 g/cm³.

In any of the embodiments described, the first thermoplastic tubular structure, second thermoplastic tubular structure, and the barrier layer could be coextruded.

In any of the embodiments described, the barrier layer could comprise one or more of the following: ethylene vinyl alcohol copolymer; polyamides; nylon; extrudable polyvinylidene chloride; poly(vinyl chloride) (PVC); methyl methacrylate-styrene copolymers (70:30 weight percent, respectively) grafted onto a diene elastomer; amorphous polyamides and crystalline polyamides (nylon-6 and nylon-66); crystalline polyesters such as polyethylene terephthalate (PET); poly(ethylene 2,6-naphthalene dicarboxylate) (PEN); polyurethanes; polycarbonates (PC); polyphenylene oxide (PPO); polyphenylene oxide/polystyrene blends; polystyrene; polyetherimide; polyalkyl methacrylates; high nitrile polymers; high acrylonitrile-styrene co- and terpolymers; high acrylonitrile-indene co- and terpolymers; homo-, co- or terpolymers high in methacrylonitrile content; all common homo-, co-, or terpolymers based on vinylidene dichloride (PVDC); and metalized oriented polypropylene film. These materials could be used neat or in combination with one or more other materials.

In any of the embodiments described, the first tubular structure could be chemically or mechanically secured to a surface of the barrier layer and the second tubular structure could be chemically or mechanically secured to an opposing surface of the barrier layer.

In particular, the multilayer pipe or liner of the present invention would include:
(a) a first thermoplastic tubular structure preferably having a minimum thickness of 875 microns (μm) and comprising an internal passage for conveying fluid;
(b) a second thermoplastic tubular structure preferably having a minimum thickness of 875 μm covering the first thermoplastic tubular structure; and
(c) a barrier layer preferably having a thickness of at least about 13 μm disposed between the first thermoplastic tubular structure and the second thermoplastic tubular structure.

The invention further provides for the first thermoplastic tubular structure and the second thermoplastic tubular structure to each comprise a polyolefin material selected from the group consisting of polypropylene, copolymers of polypropylene with other olefins, polyethylene, and copolymers of ethylene with other olefins.

In any of the embodiments described, the barrier layer could have a carbon dioxide permeability of less than 0.50 cm³/100 cm²/day/100 kPa, more preferably less than 0.10 cm³/100 cm²/day/100 kPa, and most preferably less than 0.01 cm³/100 cm²/day/100 kPa.

In any of the embodiments described, the first thermoplastic tubular structure and the second thermoplastic tubular structure could each further include a functionalized polymer such as maleic anhydride, an acid terpolymer, or an ethylene acrylic acid copolymer.

In any of the embodiments described, the first thermoplastic tubular structure and the second thermoplastic tubular structure could each comprise a hydrocarbon resin, the hydrocarbon resin having a melt flow rate of between about 10 and 40 g/10 min. at 230° C., 2160 g, and a density of between about 0.90 and 1.10 g/cm³.

In any of the embodiments described, the first thermoplastic tubular structure and the second thermoplastic tubular structure could each comprise a hydrocarbon resin, and an acid terpolymer, or an ethylene acrylic acid copolymer or a functionalized polymer such as maleic anhydride.

In any of the embodiments described, the first thermoplastic tubular structure, the second thermoplastic tubular structure, and the barrier layer could be coextruded.

In any of the embodiments described, the barrier layer could comprise one or more of the following: ethylene vinyl alcohol copolymer; polyamides; nylon; extrudable polyvinylidene chloride; poly(vinyl chloride) (PVC); methyl methacrylate-styrene copolymers (70:30 weight percent, respectively) grafted onto a diene elastomer; amorphous polyamides and crystalline polyamides (nylon-6 and nylon-66); crystalline polyesters such as polyethylene terephthalate (PET); poly(ethylene 2,6-naphthalene dicarboxylate) (PEN); polyurethanes; polycarbonates (PC); polyphenylene oxide (PPO); polyphenylene oxide/polystyrene blends; polystyrene; polyetherimide; polyalkyl methacrylates; high nitrile polymers; high acrylonitrile-styrene co- and terpolymers; high acrylonitrile-indene co- and terpolymers; high acrylonitrile-indene co- and terpolymers; homo-, co- or terpolymers high in methacrylonitrile content; all common homo-, co-, or terpolymers based on vinylidene dichloride (PVDC); and metalized oriented polypropylene films. These materials could be used neat or in combination with one or more other materials.

In any of the embodiments described, a reinforcing structure could cover the second thermoplastic layer. The reinforcing structure could include any other pipe, a steel tubular, a well tubing joint, such as a drill well tubular, a production tubing tubular, a production casing tubular, a carbon dioxide injection tubular, or a sewer line tubular.

Also described is a process for the manufacture by coextrusion of a multilayer pipe system, the process comprising:
(a) extruding a first thermoplastic tubular structure comprising (i) a polyolefin material selected from the group consisting of polypropylene, copolymers of polypropylene with other olefins, polyethylene, and copolymers of ethylene with other olefins and (ii) a functionalized polymer;
(b) the first thermoplastic tubular defining an internal passage for conveying fluids;
(c) coextruding with the first thermoplastic tubular structure, a second thermoplastic tubular structure comprising (i) a polyolefin material selected from the group consisting of polypropylene, copolymers of polypropylene with other olefins, polyethylene, and copolymers of ethylene with other olefins and (ii) a functionalized polymer;
(d) coextruding with the first thermoplastic tubular structure and the second thermoplastic tubular, a barrier layer having a minimum thickness of at least 13 μm and disposed between the first thermoplastic tubular structure and the second thermoplastic tubular structure.

The invention further provides in any of the processes described, the barrier layer could have an absolute carbon dioxide permeability of less than 0.50 cm³/100 cm²/day/100 kPa, more preferably less than 0.10 cm³/100 cm²/day/100 kPa, and most preferably less than 0.01 cm³/100 cm²/day/100 kPa.

In any of the processes described, the functionalized polymer of the first thermoplastic tubular structure and the second thermoplastic tubular structure could include maleic anhydride, an acid terpolymer, or an ethylene acrylic acid copolymer.

In any of the processes described, the first thermoplastic tubular structure and the second thermoplastic tubular structure could each comprise a hydrocarbon resin, the hydrocarbon resin having a melt flow rate of between about 10 and 40 g/10 min. at 230° C. at 2160 g, and a density of between about 0.90 and 1.10 g/cm³.

In any of the processes described, the first thermoplastic tubular structure and the second thermoplastic tubular structure could each comprise maleic anhydride, an acid terpolymer, or an ethylene acrylic acid copolymer, and a hydrocarbon resin.

In any of the processes described, the barrier layer could comprise one or more of the following: ethylene vinyl alcohol copolymer; polyamides; nylon; extrudable polyvinylidene chloride; poly(vinyl chloride) (PVC); methyl methacrylate-styrene copolymers (70:30 weight percent, respectively) grafted onto a diene elastomer; amorphous polyamides and crystalline polyamides (nylon-6 and nylon-66); crystalline polyesters such as polyethylene terephthalate (PET); poly(ethylene 2,6-naphthalene dicarboxylate) (PEN); polyurethanes; polycarbonates (PC); polyphenylene oxide (PPO); polyphenylene oxide/polystyrene blends; polystyrene; polyetherimide; polyalkyl methacrylates; high nitrile polymers; high acrylonitrile-styrene co- and terpolymers; high acrylonitrile-indene co- and terpolymers; high acrylonitrile-indene co- and terpolymers; homo-, co- or terpolymers high in methacrylonitrile content; all common homo-, co-, or terpolymers based on vinylidene dichloride (PVDC); and metalized oriented polypropylene films.

In any of the processes described, a reinforcing structure could cover the second thermoplastic layer, wherein the reinforcing structure could include a steel tubular or other pipe, a well tubing joint, such as a drill well tubular, a production tubing tubular, a production casing tubular, a carbon dioxide injection tubular, or a sewer line tubular.

In any of the processes described, the first tubular structure is chemically or mechanically secured to a surface of the barrier layer and the second tubular structure is chemically or mechanically secured to an opposing surface of the barrier layer.

### BRIEF DESCRIPTION OF THE DRAWINGS

Examples of various embodiments of this invention are shown in the attached Figures, wherein:

FIG. 1 is a cross-sectional view of a three-layer pipe;

FIG. 2 is a sectional view of FIG. 1 taken along line 2-2;

FIG. 3 is a cross-sectional view of a five-layer pipe;

FIG. 4 is a sectional view of FIG. 3 taken along line 4-4;

FIG. 5 is a cross-sectional view in a reinforced three-layer liner; and

FIG. 6 a sectional view of FIG. 5 taken along section 6-6.

### DETAILED DESCRIPTION OF THE INVENTION

The present invention provides thermoplastic pipes and liners having improved barrier properties. In one embodiment, a rigid, self-supporting, extruded multilayer pipe using a barrier layer comprising EVOH or another barrier material between two thermoplastic layers is described. Pipe of the present invention can be used to transport various liquid and gaseous materials containing carbon dioxide, hydrogen sulfide, or other corrosive gases and fluids, in services such as sewer service and the transport of corrosive chemicals. Pipe of the present invention may also be used with or without external reinforcing support. For the purposes of this invention, “fluids” will include gases and liquids, both individually and collectively. Such pipe may also be used as a liner with a reinforcement structure, such as a tubular member, in oil field applications for drill pipe, production casing, production tubing, carbon dioxide injection well tubing, or other well tubular, and flowlines and pipelines.

For the purposes of this invention, the phrase “barrier layer” means a material preferably having an absolute permeability to carbon dioxide of less than about 0.50 cm³/100 cm²/day/100 kPa, more preferably less than about 0.40 cm³/100 cm²/day/100 kPa, more preferably less than about 0.30 cm³/100 cm²/day/100 kPa, more preferably less than about 0.10 cm³/100 cm²/day/100 kPa, and most preferably less than about 0.01 cm³/100 cm²/day/100 kPa regardless of thickness. The phrase “barrier layer” specifically includes a single layer of film or polymer or blends of polymers or other materials and includes single and multiple layers of film and/or other materials. For the purposes of this invention, carbon dioxide barrier properties are determined according to ASTM D1434-03 at 65% relative humidity at 20° C. (68° F.).

Article Description

Thermoplastic pipe and liners of the present invention will now be described with reference to the Figures.

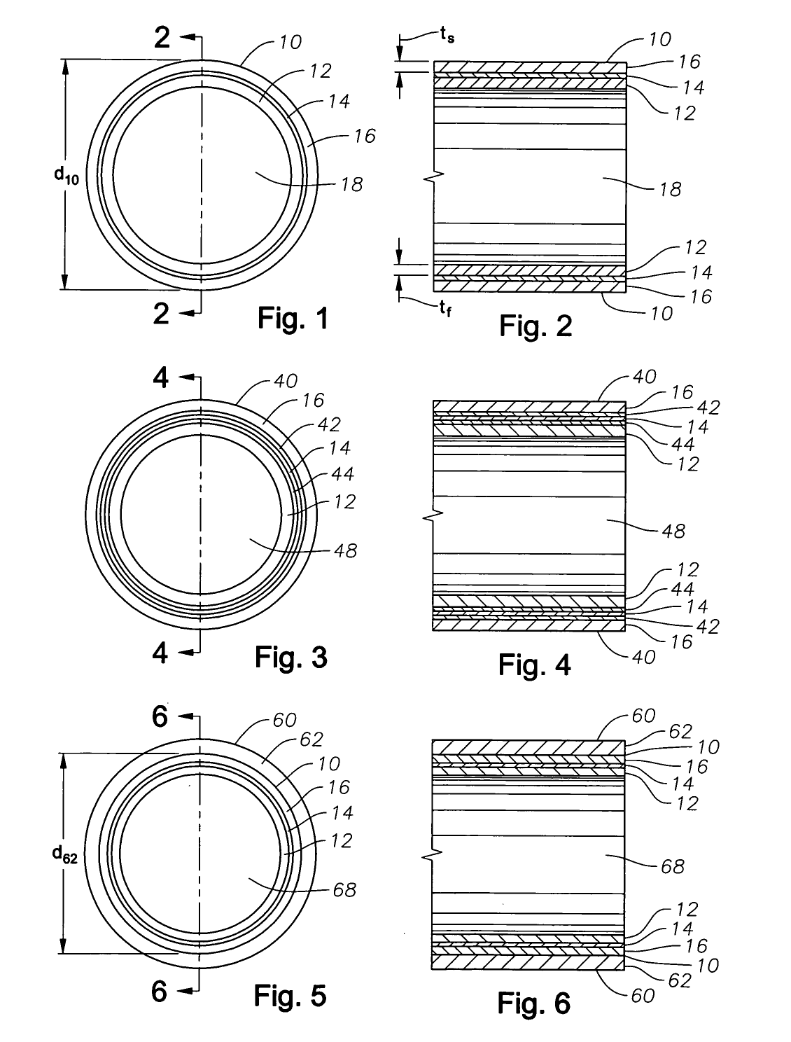

FIG. 1 shows a cross-sectional view of one embodiment of a three-layer pipe 10 in tubular form according to the present invention. The three-layer pipe 10 comprises first thermoplastic tubular structure 12 covered by barrier layer 14, which is in turn covered by second thermoplastic tubular structure 16. Each pipe, liner, and tubular structure of the present invention comprises an internal passage for conveying fluids. Three-layer pipe 10 further comprises an internal passage 18 for conveying fluids. Three-layer pipe 10 has an external diameter of d₁₀. First thermoplastic tubular structure 12 has a wall thickness of t_{f} and second thermoplastic tubular structure 16 has a wall thickness of tₛ.

FIG. 2 shows a sectional view of the three-layer pipe 10 of FIG. 1 taken at section 2-2. As in FIG. 1, FIG. 2 shows three-layer pipe 10 comprising first thermoplastic tubular structure 12, barrier layer 14, and second thermoplastic tubular structure 16. Three-layer pipe 10 further comprises an internal passage 18.

FIG. 3 shows a cross-sectional view of one embodiment of a five-layer pipe 40 in tubular form according to the present invention. The multilayer pipe 40 comprises first thermoplastic tubular structure 12, covered by first adhesive layer 44, which is in turn covered by barrier layer 14, which is in turn covered by second adhesive layer 42, which is finally covered by second thermoplastic tubular structure 16. Multilayer pipe 40 further comprises an internal passage 48 for conveying fluids.

FIG. 4 shows a sectional view of the five-layer pipe 40 of FIG. 3 taken at section 4-4. As in FIG. 3, FIG. 4 shows five-layer pipe 40 comprising first thermoplastic tubular structure 12, first adhesive layer 44, barrier layer 14, second adhesive layer 42, and second thermoplastic tubular structure 16. Multilayer pipe 40 further comprises an internal passage 48.

FIG. 5 shows a cross-sectional view of reinforced liner 60, which includes three-layer pipe 10, first thermoplastic tubular structure 12, barrier layer 14, and second thermoplastic tubular structure 16 covered by reinforcing structure 62. Reinforced liner 60 further comprises an internal passage 68 for conveying fluids. Reinforcing structure 62 has an internal diameter of d₆₂.

FIG. 6 shows a side view of reinforced liner 60 of FIG. 5 taken at section 6-6. As in FIG. 5, FIG. 6 shows reinforced liner 60 comprising three-layer pipe 10, first thermoplastic tubular structure 12, barrier layer 14, second thermoplastic tubular structure 16, and reinforcing structure 62. Reinforced liner 60 further comprises an internal passage 68.

Throughout the remaining description of the embodiments of the invention, primary reference will be made to the embodiment illustrated in FIG. 1, unless otherwise indicated. However, it will be appreciated that such description may also apply to the embodiments illustrated in the other Figures.

Thermoplastic Liner Materials

The pipes and liners of the present invention are comprised of thermoplastic materials. These materials provide necessary structural support and product containment for the piping or liner application, as well as protection to barrier layer 14. In order to utilize and protect the barrier properties of the barrier layer in a pipe or liner, the barrier layer, must be placed between layers of certain thermoplastic materials. Such thermoplastic materials serve to isolate the barrier layer from materials destructive to the barrier layer in order to obtain the advantages offered by such a barrier layer in a structure having adequate integrity and an economically justifiable basis.

First thermoplastic tubular structure 12 and second thermoplastic tubular structure 16 of the present invention may be polyolefins selected from the group consisting of homopolymers, impact copolymers, random copolymers of polypropylene, polyethylene, including low density polyethylene, high density polyethylene, and linear low density polyethylene. Additionally, first thermoplastic tubular structure 12 and second thermoplastic tubular structure 16 may comprise polypropylene and ethylene-propylene copolymers containing predominately propylene or polystryrene or polyvinyl chloride. The most preferred material for first thermoplastic tubular structure 12 and second thermoplastic tubular structure 16 comprises polypropylene impact copolymers. Polypropylene offers many advantages in such piping and liner applications including (i) chemical and moisture resistant barrier properties, (ii) environmental stress crack resistance, (iii) high stiffness to thickness ratios, (iv) good strength properties, (v) high temperature resistance and durability, and (vi) long term stability.

Additionally, first thermoplastic tubular structure 12 and second thermoplastic tubular structure 16 may include certain inorganic filler materials such as glass, talc, calcium carbonate, or other materials to improve a desired property of the thermoplastic materials.

The preferred polypropylene will have a melt flow rate of 0.3 to 2.5 g/10 min. at 230° C. and a load of 2160 g (ASTM D 1238-01) An example of a preferred polypropylene grade is PP7031 E1 marketed by ExxonMobil Chemical Company, which has a melt flow rate of 0.45 g/10 minutes at 230° C. and a load of 2160 g (ASTM D 1238-01) and a density of 0.9 g/cm³ (ASTM D972-02).

Methods of producing extruded pipe are well known in the industry and will only be generally described here. In a pipe extrusion line, a resin handling system will feed thermoplastic materials to an extruder which melts and homogenizes the thermoplastic materials to a uniform temperature and consistency. The molten thermoplastic materials are then pressurized by an extruder screw and delivered to a screen changer where major contaminants are removed. The molten materials are then fed through a die to form an annular-shaped melt stream. To maintain a constant die feed rate, a metering pump may be used between the screen changer and the die. The annular-shaped melt stream immediately enters a sizing device to solidify the thermoplastics to a thickness sufficient to transfer any stresses acting on the material while maintaining the desired shape and dimensions. The solidified annual-shaped material continues to be cooled either by contacting a cold mold, which moves along with the now formed pipe in a large pipe production, or by water spray or both. The pipe is then cut to a desired length.

To produce co-extruded pipe with multiple layers of thermoplastic materials, multiple extruders are used. Each thermoplastic material is fed separately to an extruder. The molten materials from each extruder are fed to a co-extrusion pipe die where the molten materials are combined to form the pipe with the appropriate layers of thermoplastic materials in the desired order to achieve the desired structure.

The selection of other types of thermoplastic materials for first thermoplastic tubular structure 12 and second thermoplastic tubular structure 16 is within the scope of the skilled artisan.

In order to develop appropriate and necessary structural integrity, rigidity, and fluid and gas containment properties for installation and performance of three-layer pipe 10, it is necessary that first thermoplastic tubular structure 12 and second thermoplastic tubular structure 16 have adequate wall thicknesses, t_{f} and tₛ, respectively. While the wall thickness t_{f} of first thermoplastic tubular structure 12 and wall thickness t_{f} of second thermoplastic tubular structure 16 will vary depending of the service requirements of three-layer pipe 10, it is expected that t_{f} and tₛ will be at least 875 μm (35 mil) each for first thermoplastic tubular structure 12 and for second thermoplastic tubular structure 16. For the present invention, t_{f} and tₛ should each preferably be at least 3000 μm (120 mil), more preferably at least 2500 μm (100 mil), more preferably at least 2000 μm (80 mil), more preferably at least 1500 μm (60 mil), and most preferably at least 875 μm (35 mil). Where a larger diameter multilayer pipe 10 diameter is desired, d₁₀ may be increased to 0.25 meter to 5 meters or greater and t_{f} and tₛ may be increased to 6000 μm (240 mil) or greater.

A minimum t_{f} and tₛ of 875 μm (35 mil) will result, upon insertion of three-layer pipe 10 into a tubular such as reinforcing tubular 62, in a reduction of the internal diameter of the tubular of only 3500 μm (140 mil), (excluding barrier layer 14), while providing the necessary structural integrity and rigidity to the liner and protection to barrier layer 14. Such a thickness will also allow some erosion to occur to the internal surface of first thermoplastic tubular structure 12, which is in contact with materials or tools being moved through three-layer pipe 10, while maintaining structural integrity, fluid containment, and protecting barrier layer 14. It is appreciated that greater wall thicknesses will be necessary for higher pressure services and more severe operating conditions. The determination of proper t_{f} of first thermoplastic tubular structure 12 and tₛ of second thermoplastic tubular structure 16 of three-layer pipe 10 is within the scope of the skilled artisan.

It is not necessary that the thickness of first thermoplastic tubular structure 12 and second thermoplastic tubular structure 16 be the same in a given application. In fact, it may be desirable to make first thermoplastic tubular structure 12 of greater wall thickness than second thermoplastic tubular structure 16 to allow for some erosion to occur to the surface of first thermoplastic tubular structure 12 caused by contact with the materials or tools being moved through three-layer pipe 10.

Additionally, it is not necessary that the composition of first thermoplastic tubular structure 12 and second thermoplastic tubular structure 16 be the same in a given application. For example, first thermoplastic tubular structure 12 could be of a material selected to be specifically compatible with the fluid to be conveyed through three-layer pipe 10, while second thermoplastic tubular structure 16 could be of a less expense material that need not be compatible with the fluid to be conveyed.

Additionally, where three-layer pipe 10 will not be reinforced by reinforcing structure 62 as shown in FIG. 5, but will provide a stand-alone piping system, it may be desirable to increase t_{f} and tₛ as much as necessary to accommodate the operating pressures, temperatures, and other requirements of such piping system. The determination of proper t_{f} and tₛ as three-layer pipe 10 without reinforcement is within the scope of the skilled artisan.

Barrier Layer

Barrier layer 14 is preferably selected from a group of materials that provide the necessary barrier against carbon dioxide and other gases. Depending on the application of the present invention, it is preferable that the barrier layer 14 comprise a material which provides an absolute permeability to carbon dioxide gas of less than 0.50 cm³/100 cm²/day/100 kPa, more preferably less than about 0.40 cm³/100 cm²/day/100 kPa, more preferably less than about 0.30 cm³/100 cm²/day/100 kPa, more preferably less than about 0.10 cm³/100 cm²/day/100 kPa, and most preferably less than about 0.01 cm³/100 cm²/day/100 kPa. For the purposes of the present invention, barrier layer 14 thickness should preferably be at least 13 μm (0.5 mil) mils and preferably no more than 250 μm (10 mil), more preferably no more than 175 μm (7 mil), more preferably no more than 125 μm (5 mil), and most preferably no more than 60 μm (2.5 mil).

As previously mentioned, the preferred embodiment of barrier layer 14 in FIG. 1 is an ethylene vinyl alcohol (EVOH) copolymer, although other acceptable barrier materials are available. EVOH copolymer resins offer excellent barrier properties with respect to gases such as oxygen and nitrogen, and particularly to carbon dioxide. Against carbon dioxide, EVOH films may provide permeabilities in the range of about 0.003 to about 0.50 cm³/100 cm²/day/100 kPa per 25 μm (1 mil) of film thickness (ASTM D1434-03). In order to provide an acceptable barrier to carbon dioxide and other corrosive gases, it is recommended that the thickness of barrier layer 14 be such to provide an absolute permeability barrier in the range of less than about 0.50 cm³/100 cm²/day/100 kPa at the temperature at which the pipe or liner will be operated. It is recommended that barrier layer 14 be at least about 13 μm (0.5 mil) in thickness. If the EVOH material selected has a permeability of about 0.003 cm³/100 cm²/day/100 kPa per 25 μm (1 mil) of film thickness, a thickness of less than 25 μm (1 mil) would be needed to provide a permeability of 0.50 cm³/100 cm²/day/100 kPa.

The ethylene vinyl alcohol (EVOH) copolymers used in the present invention generally have an ethylene content of about 25 to about 50 mole percent. It is highly preferred that the percent ethylene in the EVOH be at least 27 mole percent so that the EVOH is flexible during the coextrusion process.

EVOH is commercially available under a variety of tradenames. The Kuraray Company markets ethylene vinyl alcohol copolymers under the tradename EVAL® Resins. Examples include EVAL® Resin Type L101A which has the following properties: ethylene content of 27 mole percent; MI of 3.9 g/10 min. at 210° C., 2160 g (ASTM D1238-01); density of 1.20 g/cm³ (ASTM D1505-03); melting point of 191° C. (DSC); crystallization temperature of 167° C.; a glass transition temperature of 72° C. (Dynamic Viscoelasticity); an extruder melt temperature range of 200° C.-240° C.; and a carbon dioxide permeability of 0.003 cm³/100 cm²/day/100 kPa per 25 μm (1 mil) of film thickness at 65% relative humidity at 68° F. (ASTM D1434-03).

Also useful is EVAL® Resin Type G156A which has the following properties: ethylene content of 48 mole percent; MI of 14.7 g/10 min. at 210° C., 2160 g (ASTM D1238-01); density of 1.12 g/cm³ (ASTM D1505-03); melting point of 158° C. (DSC); crystallization temperature of 136° C.; a glass transition temperature of 49° C. (Dynamic Viscoelasticity); an extruder melt temperature range of 180° C.-250° C.; and a carbon dioxide permeability of 0.32 cm³/100 cm²/day/100 kPa per 25 μm (1 mil) of film thickness at 65% relative humidity at 68° F. (ASTM D1434-03).

Although EVOH polymers are the preferred barrier layers, other useful barrier layer materials include, but are not limited to:
(i) EVOH mixed with other polyolefins, including, but not limited to polypropylene, copolymers of propylene with other olefins, polyethylene, including low density polyethylene, high density polyethylene, linear low density polyethylene, and copolymers of ethylene with other olefins;
(ii) polyamides like nylon, particularly the nylons manufactured by Mitsubishi Gas Co. and sold under the tradename MXD-6 and having the following physical characteristics: density of 1.21 g/cm³ (ASTM D792-00), and glass transition temperature 102° C.;
(iii) extrudable polyvinylidene chloride materials like extrudable polyvinylidene chloride available under the tradename XO-5253-16 from Dow Chemical Co. as the supplier and having the physical characteristics as follows: density 1.74 g/cm³; melting point 160° C. and glass transition temperature of −1° C.;
(iv) poly(vinyl chloride) (PVC);
(v) methyl methacrylate-styrene copolymers (70:30 weight percent, respectively) grafted onto a diene elastomer;
(vi) amorphous polyamides (Trogamid T) available from Degussa AG and crystalline polyamides (nylon-6 and nylon-66);
(vii) crystalline polyesters such as polyethylene terephthalate (PET);
(viii) poly(ethylene 2,6-naphthalene dicarboxylate) (PEN);
(ix) polyurethanes;
(x) polycarbonates (PC);
(xi) polyphenylene oxide (PPO);
(xii) polyphenylene oxide/polystyrene blends;
(xii) polyphenylene oxide/polystyrene blends;
(xiv) polystyrene;
(xv) polyetherimide;
(xvi) polyalkyl methacrylates;
(xvii) high nitrile polymers such as high acrylonitrile-methyl acrylate copolymers grafted onto a performed poly (butadiene-acrylonitrile) elastomer;
(xviii) high acrylonitrile-styrene co- and terpolymers;
(xix) high acrylonitrile-indene co- and terpolymers;
(xx) homo-, co- or terpolymers high in methacrylonitrile content;
(xxi) all common homo-, co-, or terpolymers based on vinylidene dichloride (PVDC); and
(xxii) metalized oriented polypropylene films.

The selection of barrier layer 14 and the necessary thickness for a given application is well within the purview of the skilled artisan and is not limited to those above listed materials.

Methods of Disposing Barrier Layer between Thermoplastic Layers

The preferred embodiments, there are two methods of disposing barrier layer 14 between the two thermoplastic layers. The first method results in a three-layer pipe 10 in which the barrier layer is bound to the thermoplastic layers without the use separate adhesive layers. The second method results in a five-layer liner system 40 which uses separate adhesive layers to bind barrier layer 14 to first thermoplastic tubular structure 12 and second thermoplastic tubular structure 16.

Three Layer Liners Using No Separate Adhesive Layers

It is known in the art that certain material useful as barrier layer 14 as described above, such as EVOH, may not readily adhere to certain thermoplastics such as polypropylene. This is particularly true during co-extrusion manufacturing operations. To overcome this lack of adherence, it has been found that the addition of small amounts of functionalized polymers, particularly EVOH, or an acid terpolymer or an ethylene acrylic acid copolymer to a thermoplastic will allow certain materials to readily adhere to the thermoplastic, particularly during co-extrusion manufacturing processes. A preferred functionalized polymer is maleic anhydride which may be added in the amount of between approximately 0.003 and 1.0 wt. percent of the thermoplastic. Maleic anhydride may be added by itself as a neat component or may be added as part of a functionalized polymer.

Maleic anhydride is commercially available under a variety of tradenames. A useful maleic anhydride additive is marketed by ExxonMobil Chemical Company under the tradename EXXELOR® PO 1020, which is a maleic anhydride functionalized homopolypropylene material with the following properties: melt flow index of 125 g/10 min. at 190° C., 1200 g (ASTM D1238-01); melt flow rate of >200 g/10 min. at 230° C., 2160 g (ASTM D1238-01); density of 0.90 g/cm³ (DIN 53479); and melting point of 160° C. (DSC—Exxon). The maleic anhydride content of this product is approximately 6%.

Another preferred material to assist in the bonding of first thermoplastic tubular structure 12 and second thermoplastic tubular structure 16 to barrier layer 14 is an acid terpolymer. A useful terpolymer is marketed by ExxonMobil Chemical Company under the tradename ESCOR® AT 310 with the following properties: melt index of 6.0 g/10 min. (ExxonMobil Method); density of 0.943 g/cm³ (ExxonMobil Method); and an acid number of 45 mg KOH/g polymer (ExxonMobil Method).

Another preferred material to assist in the bonding of first thermoplastic tubular structure 12 and second thermoplastic tubular structure 16 to barrier layer 14 is an ethylene acrylic acid copolymer. A useful ethylene acrylic acid copolymer is marketed by ExxonMobil Chemical Company under the tradename ESCOR® EAA with the following properties: melt index of 36 g/10 min. (ASTM D1238-01); density of 0.948 g/cm³ (ASTM D4703-03/ASTM D1505-03); and an acrylic acid content of 11% wt. (ExxonMobil Method).

In a one embodiment of the present invention, three-layer pipe 10,
(i) first thermoplastic tubular structure 12 and second thermoplastic tubular preferred melt flow rate from about 0.30 to about 2.5 g/10 min. at 230° C. at a load of 2160 g and about 0.003 to about 1.0 parts by weight of maleic anhydride and
(ii) barrier layer 14 comprises an EVOH copolymer having an ethylene content of about 20 to 60 mole percent, more preferably 25 to 50 mole percent, and most preferably 27 to 48 mole percent.

In other embodiments of the present invention of three-layer pipe 10,
(i) first thermoplastic tubular structure 12 and second thermoplastic tubular structure 16 comprise about 90-99.99 parts by weight high density polyethylene with at least 0.003 parts by weight of maleic anhydride and barrier layer 14 comprises an EVOH copolymer having an ethylene content of about 20 to 60 mole percent, more preferably 25 to 50 mole percent, and most preferably 27 to 48 mole percent or
(ii) first thermoplastic tubular structure 12 and second thermoplastic tubular structure 16 comprise about 90-99.99 parts by weight linear low density polyethylene with at least 0.003 part by weight of maleic anhydride and barrier layer 14 comprises an EVOH copolymer having an ethylene content of about 20 to 60 mole percent, more preferably 25 to 50 mole percent, and most preferably 27 to 48 mole percent.
(iii) first thermoplastic tubular structure 12 and second thermoplastic tubular structure 16 comprise about 90-99.99 parts by weight linear low density polyethylene with at least 0.003 part by weight of an acid terpolymer and barrier layer 14 comprises an EVOH copolymer having an ethylene content of about 20 to 60 mole percent, more preferably 25 to 50 mole percent, and most preferably 27 to 48 mole percent.
(iv) first thermoplastic tubular structure 12 and second thermoplastic tubular structure 16 comprise about 90-99.99 parts by weight linear low density polyethylene with at least 0.003 part by weight of an ethylene acrylic acid copolymer and barrier layer 14 comprises an EVOH copolymer having an ethylene content of about 20 to 60 mole percent, more preferably 25 to 50 mole percent, and most preferably 27 to 48 mole percent.
   ethylene content of about 20 to 60 mole percent, more preferably 25 to 50 mole percent, and most preferably 27 to 48 mole percent.

It has also been determined that mixtures of a polypropylene and hydrocarbon resin for thermoplastic tubular structures 12 and 16 also provide benefits such as decreased carbon dioxide permeability. An example of a preferred hydrocarbon resin is PA 609A marketed by ExxonMobil Chemical Company with the following properties: melt flow rate of 25 g/10 min. at 230° C., 2160 g (ASTM D1238-01), and a density of 0.97 g/cm³ (ASTM D792-00). Other useful resins include hydrogenated ketone resins, polyamide resins, colophonium, coumarone resins, terpene resins, chlorinated aliphatic, aromatic hydrocarbon resins, and mixtures thereof. Other useful resins include polymers of steam cracked petroleum distillate, coke oven gas, cracked naphtha, gas oil, terpene, and mixtures thereof. A mixture of a hydrocarbon resin with the polypropylene and a maleic anhydride provides a good material for first thermoplastic tubular structure 12 and second thermoplastic tubular structure 16. It as been found that the resin content should not exceed 12 wt. % of the total polypropylene and hydrocarbon resin and operating temperature for such mixture should not exceed 48° C.

It is preferred that each layer of three layer pipe 10 be mechanically or chemically secured or otherwise bonded to the adjacent layer, i.e. that first thermoplastic tubular structure 12 is mechanically or chemically secured or otherwise bonded to barrier layer 14 which is mechanically or chemically secured or otherwise bonded second thermoplastic tubular structure 16. However, in certain applications, it may be desirable that that there be interposed additional layers or that the layers not be mechanically or chemically secured or otherwise bonded to the adjacent layer.

Five Layer Liners Using Separate Adhesive Layers—

Another embodiment of the invention includes a five-layer pipe 40 as shown in FIG. 3 and FIG. 4. As seen in FIG. 3 and FIG. 4, first adhesive layer 44 and second adhesive layer 42 may be used to adhere barrier layer 14 to first thermoplastic tubular structure 12 and second thermoplastic tubular structure 16 in five-layer pipe 40. Many adhesive layer materials are commercially available. The adhesive layers 42 and 44 used in the present invention preferably use a maleic anhydride, such as EXXELOR® PO 1020, as referenced above.

Thermoplastic Pipes and Thermoplastic Liners with Reinforced Tubulars

Thermoplastic pipes of the present invention may be used with or without external reinforcement. Thermoplastic pipes of the present invention, in certain applications need no external reinforcing support, such as a carbon steel or other rigid tubular, and can be used alone to transport various liquid and gaseous materials. In such applications, three-layer pipe 10 or five-layer pipe 40, with adequate wall thickness, may be used directly as a piping system to transport fluids and gases.

In applications where the liner system of the present invention will be exposed to operating environments beyond the capacity of the multilayer pipe of the present invention, particularly in high-pressure, high temperature down-hole applications, it is necessary that another tubular, reinforcing tubular 62, externally reinforce the multilayered pipe. Typical tubulars useful for reinforcing the present liner system would be carbon steel or other metallic tubulars such as drill pipe, production casing, production tubing, flowlines, pipelines, carbon dioxide injection well tubing, or nearly any other piping tubular. In non-oil field applications, such sewer service and chemical transport of various corrosive materials, a standard carbon steel tubular or pipe or any other rigid tubular may be used as a reinforcing structure. In such applications, the multilayer pipe may become a liner to the reinforcing structure.

FIG. 5 shows one embodiment of a multilayer pipe of the present invention used as a liner in a tubular. FIG. 5 shows a cross-sectional view of a reinforced liner system 60 comprised of reinforcing tubular 62 covering three-layer pipe 10 with first thermoplastic tubular structure 12, barrier layer 14, and second thermoplastic tubular structure 16.

The thermoplastic pipes and thermoplastic liners of the present invention may be prepared via conventional means including coextrusion and laminating according to conditions typically employed to prepare coextruded and laminated structures. It is to be appreciated that conventional fabrication techniques can be employed to form the required liners and liner systems, including tubular articles. If an optional tie layer is to be employed, as described hereinabove, then a conventional coextrusion die can be employed.

Method of Installation in Reinforcing Tubulars

In most applications, three-layer pipe 10 and five-layer pipe 40 will require reinforcing tubular 62 to provide necessary support and protection of the multilayer pipe. It such applications, it is useful to manufacture the multilayer pipe to have an external diameter slightly greater than the interior diameter of reinforcing tubular 62.

In order to insert the multilayer pipe into reinforcing tubular 62, it will then be necessary to reduce the external diameter of the multilayer pipe to a diameter less than the internal diameter d₆₂ of reinforcing tubular 62. The external diameter of the multilayer pipe may be reduced by squeezing or otherwise reducing the shape and size of the multilayer pipe.

After the diameter of the multilayer pipe is reduced, the pipe may then be inserted into reinforcing tubular 62. After insertion, the multilayer pipe may be expanded into close contact with the internal surface of reinforcing tubular 62: (i) by drawing a heating element through the interior of multilayer pipe, (ii) by using an interior plug to physically expand the multilayer pipe, (iii) by applying internal pressure to the multilayer pipe, or (iv) by allowing the multilayer pipe to expand back to its original internal diameter by relaxation. The most preferred method of installing the multilayer pipe into reinforcing tubular 62 is by stretching multilayer pipe by pulling a length of the pipe through reinforcing tubular 62. The pulled length of the multilayer pipe is then allowed to relax and expand to its original diameter inside reinforcing tubular 62. This installation method provides intimate contact between the multilayer pipe and reinforcing tubular 62. Other examples of methods to install thermoplastic liners into oilfield tubulars is set forth in U.S. Pat. No. 5,320,388, which is incorporated by reference in its entirety.

Although the preferred installation process is described above, it may be desirable to apply a reinforcing means other than a steel tubular to multilayer pipes of the present invention. Other reinforcing means are available which would include a wire mesh or a glass epoxy wrap other wrap material applied around the external surface of the multilayer pipe.

Having now fully described this invention, it will be appreciated by those skilled in the art that the invention can be performed within a wide range of parameters within what is claimed, without departing from the spirit and scope of the invention.

1. A multilayer pipe comprising:
(a) a first thermoplastic tubular structure comprising (i) a polyolefin material selected from the group consisting of polypropylene, copolymers of polypropylene with other olefins, polyethylene, and copolymers of ethylene with other olefins and (ii) a functionalized polymer, an acid terpolymer, or an ethylene acid copolymer;
(b) a second thermoplastic tubular structure comprising (i) a polyolefin material selected from the group consisting of polypropylene, copolymers of polypropylene with other olefins, polyethylene, and copolymers of ethylene with other olefins and (ii) a functionalized polymer, an acid terpolymer, or an ethylene acid copolymer;
(c) the second thermoplastic tubular covering the first thermoplastic tubular structure; and
(d) a barrier layer disposed between the first thermoplastic tubular structure and the second thermoplastic tubular structure.

2. The multilayer pipe of claim 1, wherein the functionalized polymer is maleic anhydride.

3. The multilayer pipe of claim 1 wherein the barrier layer has a carbon dioxide permeability of less than 0.50 cm³/100 cm²/day/100 kPa.

4. The multilayer pipe of claim 1 wherein the barrier layer has a carbon dioxide permeability of less than 0.10 cm³/100 cm²/day/100 kPa.

5. The multilayer pipe of claim 1 wherein the barrier layer has a carbon dioxide permeability of less than 0.01 cm³/100 cm²/day/100 kPa.

6. The multilayer pipe of claim 1 wherein the first thermoplastic tubular structure and the second thermoplastic tubular structure each further comprise a hydrocarbon resin, the hydrocarbon resin having a melt flow rate of between about 10 and 40 g/10 min. at 230° C. at 2160 g and a density of between about 0.90 and 1.10 g/cm³.

7. The multilayer pipe of claim 1 wherein the first thermoplastic tubular structure, second thermoplastic tubular structure, and the barrier layer are coextruded.

8. The multilayer pipe of claim 1 wherein the barrier layer comprises an ethylene vinyl alcohol copolymer.

9. The multilayer pipe of claim 6 wherein the barrier layer comprises an ethylene vinyl alcohol copolymer.

10. The multilayer pipe of claim 1 wherein the barrier layer has a thickness of at least 13 μm and no more than 250 μm.

11. The multilayer pipe of claim 1 wherein the barrier layer has a thickness of at least 13 μm and no more than 60 μm.

12. The multilayer pipe of claim 8 wherein the first thermoplastic tubular structure, second thermoplastic tubular structure, and the barrier layer are coextruded.

13. The multilayer pipe of claim 1 wherein the barrier layer comprises one or more of the following: polyamide; nylon; extrudable polyvinylidene chloride; poly(vinyl chloride) (PVC); methyl methacrylate-styrene copolymers (70:30 weight percent, respectively) grafted onto a diene elastomer; amorphous polyamides and crystalline polyamides (nylon-6 and nylon-66); crystalline polyesters such as polyethylene terephthalate (PET); poly(ethylene 2,6-naphthalene dicarboxylate) (PEN); polyurethane; polycarbonate (PC); polyphenylene oxide (PPO); polyphenylene oxide/polystyrene blends; polystyrene; polyetherimide; polyalkyl methacrylate; high nitrile polymer; high acrylonitrile-styrene co- and terpolymers; high acrylonitrile-indene co- and terpolymers; homo-, co- or terpolymers high in methacrylonitrile content; all common homo-, co-, or terpolymers based on vinylidene dichloride (PVDC); and metalized oriented polypropylene film.

14. The multilayer pipe of claim 12 wherein the functionalized polymer is maleic anhydride.

15. A multilayer pipe comprising:
(a) a first thermoplastic tubular structure having a thickness of at least 875 μm;
(b) a second thermoplastic tubular structure having a thickness of at least 875 μm covering the first thermoplastic tubular structure; and
(c) a barrier layer having a thickness of at least 13 μm disposed between the first thermoplastic tubular structure and the second thermoplastic tubular structure.

16. The multilayer pipe of claim 15 wherein the first thermoplastic tubular structure and the second thermoplastic tubular structure each comprise a polyolefin material selected from the group consisting of polypropylene, copolymers of polypropylene with other olefins, polyethylene, and copolymers of ethylene with other olefins.

17. The multilayer pipe of claim 16 wherein the barrier layer has a carbon dioxide permeability of less than 0.50 cm³/100 cm²/day/100 kPa.

18. The multilayer pipe of claim 16 wherein the barrier layer has a carbon dioxide permeability of less than 0.10 cm³/100 cm²/day/100 kPa.

19. The multilayer pipe of claim 16 wherein the barrier layer has a carbon dioxide permeability of less than 0.01 cm³/100 cm²/day/100 kPa.

20. The multilayer pipe of claim 16 wherein the first thermoplastic tubular structure and the second thermoplastic tubular structure each further comprise a functionalized polymer, an acid terpolymer, or an ethylene acid copolymer.

21. The multilayer pipe of claim 20, wherein the functionalized polymer is maleic anhydride.

22. The multilayer pipe of claim 16 wherein the first thermoplastic tubular structure and the second thermoplastic tubular structure each further comprise a hydrocarbon resin, the hydrocarbon resin having a melt flow rate of between about 10 and 40 g/10 min. at 230° C. at 2160 g and a density of between about 0.90 and 1.10 g/cm³.

23. The multilayer pipe of claim 16 wherein the first thermoplastic tubular structure and the second thermoplastic tubular structure each further comprise a maleic anhydride functionalized polymer and a hydrocarbon resin.

24. The multilayer pipe of claim 16 wherein the first thermoplastic tubular structure, second thermoplastic tubular structure, and the barrier layer are coextruded.

25. The multilayer pipe of claim 16 wherein the barrier layer comprises an ethylene vinyl alcohol copolymer.

26. The multilayer pipe of claim 22 wherein the barrier layer comprises an ethylene vinyl alcohol copolymer.

27. The multilayer pipe of claim 25 wherein the first thermoplastic tubular structure, second thermoplastic tubular structure, and the barrier layer are coextruded.

28. The multilayer pipe of claim 15 wherein the barrier layer comprises one or more of the following: polyamide; nylon; extrudable polyvinylidene chloride; poly(vinyl chloride) (PVC); methyl methacrylate-styrene copolymers (70:30 weight percent, respectively) grafted onto a diene elastomer; amorphous polyamides and crystalline polyamides (nylon-6 and nylon-66); crystalline polyesters such as polyethylene terephthalate (PET); poly(ethylene 2,6-naphthalene dicarboxylate) (PEN); polyurethane; polycarbonate (PC); polyphenylene oxide (PPO); polyphenylene oxide/polystyrene blends; polystyrene; polyetherimide; polyalkyl methacrylate; high nitrile polymer; high acrylonitrile-styrene co- and terpolymers; high acrylonitrile-indene co- and terpolymers; homo-, co- or terpolymers high in methacrylonitrile content; all common homo-, co-, or terpolymers based on vinylidene dichloride (PVDC); and a metalized oriented polypropylene film.

29. The multilayer pipe of claim 15 wherein the first tubular structure is chemically or mechanically secured to a surface of the barrier layer and the second tubular structure is chemically or mechanically secured to an opposing surface of the barrier layer.

30. The multilayer pipe of claim 15 wherein the barrier layer has a thickness of no more than 250 μm.

31. The multilayer pipe of claim 15 wherein the barrier layer has a thickness of no more than 60 μm.

32. A reinforced multilayer pipe comprising:
(a) a first thermoplastic tubular structure;
(b) a second thermoplastic tubular structure covering the first thermoplastic tubular structure;
(c) a reinforcing structure covering the second thermoplastic tubular structure; and
(d) a barrier layer disposed between the first thermoplastic tubular structure and the second thermoplastic tubular structure.

33. The reinforced multilayer pipe of claim 32 wherein the first thermoplastic tubular structure, the barrier layer, and the second thermoplastic tubular structure are coextruded.

34. The reinforced multilayer pipe of claim 32 wherein the barrier layer comprises one or more of the following: polyamide; nylon; extrudable polyvinylidene chloride; poly(vinyl chloride) (PVC); methyl methacrylate-styrene copolymers (70:30 weight percent, respectively) grafted onto a diene elastomer; amorphous polyamides and crystalline polyamides (nylon-6 and nylon-66); crystalline polyesters such as polyethylene terephthalate (PET); poly(ethylene 2,6-naphthalene dicarboxylate) (PEN); polyurethane; polycarbonate (PC); polyphenylene oxide (PPO); polyphenylene oxide/polystyrene blends; polystyrene; polyetherimide; polyalkyl methacrylate; high nitrile polymer; high acrylonitrile-styrene co- and terpolymers; high acrylonitrile-indene co- and terpolymers; homo-, co- or terpolymers high in methacrylonitrile content; all common homo-, co-, or terpolymers based on vinylidene dichloride (PVDC); and a metalized oriented polypropylene film.

35. The reinforced multilayer pipe of claim 32 wherein the barrier layer has a carbon dioxide permeability of less than 0.10 cm³/100 cm²/day/100 kPa.

36. The reinforced multilayer pipe of claim 32 wherein the barrier layer has a carbon dioxide permeability of less than 0.01 cm³/100 cm²/day/100 kPa.

37. The reinforced multilayer pipe of claim 32 wherein the reinforcement structure is a steel tubular.

38. The reinforced multilayer pipe of claim 32 wherein the reinforcing structure is a drill well tubular.

39. The reinforced multilayer pipe of claim 32 wherein the reinforcing structure is a production tubing tubular.

40. The reinforced multilayer pipe of claim 32 wherein the reinforcing structure is a production casing tubular.

41. The reinforced multilayer pipe of claim 32 wherein the reinforcing structure is a sewer line tubular.

42. The reinforced multilayer pipe of claim 32 wherein the barrier layer has a thickness of at least 13 μm and no more than 250 μm.

43. The reinforced multilayer pipe of claim 32 wherein the barrier layer has a thickness of at least 13 μm and no more than 60 μm.

44. The multilayer pipe of claim 32 wherein the barrier layer comprises an ethylene vinyl alcohol copolymer.

45. A well tubing joint comprising:
(a) a first thermoplastic tubular structure;
(b) a second thermoplastic tubular structure covering the first thermoplastic tubular structure;
(c) a rigid tubular section covering the second thermoplastic tubular structure; and
(d) a barrier layer disposed between the first thermoplastic tubular structure and the second thermoplastic tubular structure.

46. The well tubing joint of claim 45 wherein the first and second thermoplastic layer comprise a polyolefin material selected from the group consisting of polypropylene, copolymers of polypropylene with other olefins, polyethylene, and copolymers of ethylene with other olefins.

47. The well tubing joint of claim 45 wherein the first and second thermoplastic layers further comprise a functionalized polymer, an acid terpolymer, or an ethylene acid copolymer.

48. The well tubing joint of claim 47, wherein the functionalized polymer is maleic anhydride.

49. The well tubing joint of claim 45 wherein the rigid tubular section comprises a steel tubular.

50. The well tubing joint of claim 45 wherein the first thermoplastic tubular structure, the barrier layer, and the second thermoplastic tubular structure are coextruded.

51. The well tubing joint of claim 45 wherein the barrier layer has a carbon dioxide permeability of less than 0.50 cm³/100 cm²/day/100 kPa.

52. The well tubing joint of claim 45 wherein the barrier layer has a carbon dioxide permeability of less than 0.10 cm³/100 cm²/day/100 kPa.

53. The well tubing joint of claim 45 wherein the barrier layer has a carbon dioxide permeability of less than 0.01 cm³/100 cm²/day/100 kPa.

54. The well tubing joint of claim 45 wherein the barrier layer has a thickness of at least 13 μm and no more than 250 μm.

55. The well tubing joint of claim 45 wherein the barrier layer has a thickness of at least 13 μm and no more than 60 μm.

56. A process for the manufacture of a multilayer pipe, the process comprising:
(a) extruding a first thermoplastic tubular structure comprising (i) a polyolefin material selected from the group consisting of polypropylene, copolymers of polypropylene with other olefins, polyethylene, and copolymers of ethylene with other olefins and (ii) a functionalized polymer, an acid terpolymer, or an ethylene acid copolymer;
(b) coextruding with the first thermoplastic tubular structure, a second thermoplastic tubular structure comprising (i) a polyolefin material selected from the group consisting of polypropylene, copolymers of polypropylene with other olefins, polyethylene, and copolymers of ethylene with other olefins and (ii) a functionalized polymer, an acid terpolymer, or an ethylene acid copolymer;
(d) coextruding with the first thermoplastic tubular structure and the second thermoplastic tubular, a barrier layer having a minimum thickness of at least 13 μm and disposed between the first thermoplastic tubular structure and the second thermoplastic tubular structure.

57. The process of claim 56, wherein the functionalized polymer is maleic anhydride.

58. The process of claim 56 wherein the coextruded barrier layer has a carbon dioxide permeability of less than 0.50 cm³/100 cm²/day/100 kPa.

59. The process of claim 56 wherein the coextruded barrier layer has a carbon dioxide permeability of less than 0.1 cm³/100 cm²/day/100 kPa.

60. The process of claim 56 wherein the coextruded barrier layer has a carbon dioxide permeability of less than 0.01 cm³/100 cm²/day/100 kPa.

61. The process of claim 56 wherein the barrier layer comprises ethylene vinyl alcohol.

62. The process of claim 56 further comprising placing the multilayered pipe inside a reinforcing structure.

63. The process of claim 56 wherein the first tubular structure is chemically or mechanically secured to a surface of the barrier layer and the second tubular structure is chemically or mechanically secured to an opposing surface of the barrier layer.
